(19) United States
(12) Patent Application Publication
(10) Pub. No.: US 2026/0164423 A1
(43) Pub. Date: Jun. 11, 2026

(54) Secondary Cell (SCell) Deactivation Timer in Cross-Carrier Scheduling

(71) Applicant: Telefonaktiebolaget LM Ericsson (publ), Stockholm (SE)

(72) Inventors: Zhenhua Zou, Solna (SE); Mattias Bergström, Sollentuna (SE)

(21) Appl. No.: 18/701,035

(22) PCT Filed: Sep. 23, 2022
(86) PCT No.: PCT/SE2022/050852

§ 371 Date: Apr. 12, 2024

Related U.S. Application Data
(60) Provisional application No. 63/255,608, filed on Oct. 14, 2021.

(51) Int. Cl. H04W 72/12; H04B 7/06; H04W 72/21; H04W 80/02

(52) U.S. Cl. CPC H04W 72/12; H04B 7/0626; H04W 72/21; H04W 80/02

(57) ABSTRACT

Methods to ensure that a SCell configured to schedule a PCell or PSCell is not deactivated due to the expiry of the SCell Deactivation timer. An example method is carried out by a network node serving a wireless device and comprises the step of determining (110) that a secondary cell configured for the wireless device is configured for cross-carrier scheduling of a primary cell configured for the wireless device. The method further comprises the step of, responsive to this determining, taking (120) one or more actions to prevent deactivation of the secondary cell.

### TECHNICAL FIELD

This document is generally directed to wireless communications and is more directly related to the activation and deactivation of secondary cells in multi-carrier wireless communications.

### BACKGROUND

Members of the 3rd-Generation Partnership Project (3GPP) are developing Release 17 of the 3GPP specifications. This includes a work item regarding dynamic spectrum scheduling (3GPP document #RP-193260, revised in RP-211345), where one of the objectives is to specify the Physical Downlink Control Channel (PDCCH) for secondary cell (SCell) scheduling of the Physical Downlink Shared Channel and Physical Uplink Shared Channel on the primary cell (PCell)—i.e., cross carrier scheduling (CCS). The total PDCCH blind decoding budget will not be changed.

In what follows in this document, cross-carrier scheduling is limited to within the same cell group associated with one Medium Access Control (MAC) entity. Thus, it is only the SCells in the Master Cell Group (MCG) that can schedule the PCell in the MCG. Similarly, it is only the SCells in a Secondary Cell Group (SCG) that can schedule the PCell in the SCG. Note that a PCell in an SCG is also called a Primary Secondary Cell, or PSCell. Without loss of generality, this disclosure may use the term PCell to indicate either the PCell in the MCG or PCell in the SCG (called PSCell).

The Carrier Indicator Field (CIF) on the PDCCH allows the PDCCH of a serving cell to schedule resources on another serving cell, i.e., cross-carrier scheduling. However, this comes with the following restrictions:
When cross-carrier scheduling from an SCell to PCell is not configured, a PCell can only be scheduled via its PDCCH.
When cross-carrier scheduling from an SCell to PCell is configured, the PDCCH on that SCell can schedule the PCell's PDSCH and PUSCH, and the PDCCH on the PCell can also schedule the PCell's PDSCH and PUSCH, but the PDCCH on the PCell cannot schedule PDSCH and PUSCH on any other cell. Only one SCell in a cell group can be configured to be used for cross-carrier scheduling to the PCell.
When an SCell is configured with a PDCCH, that cell's PDSCH and PUSCH are always scheduled by the PDCCH on the same SCell.
When an SCell is not configured with a PDCCH, that SCell's PDSCH and PUSCH are always scheduled by a PDCCH on another serving cell.
The scheduling PDCCH and the scheduled PDSCH/PUSCH can use the same or different numerologies.

In short, when cross-carrier scheduling (CCS) from an SCell to its PCell is configured, then: the PCell is still self-schedulable; cross-carrier scheduling from PCell to another SCell is not allowed; and configuring two or more SCells to schedule the PCell is not allowed. The SCell configured with cross-carrier scheduling (CCS) to PCell/PSCell cannot be cross-carrier-scheduled by another cell.

The SCell configured with cross-carrier scheduling (CCS) to PCell/PSCell may be referred to as a ‘sSCell’ (scheduling SCell). When CCS from an SCell (sSCell) to PCell/PSCell is configured, the user equipment (UE) monitors Type 0/0A/1/2 common search space (CSS) sets, for the Downlink Control Information (DCI) formats associated with those search space sets, only on the PCell/PSCell and not on the sSCell. Configuration of Type 3 CSS set for DCI formats 2_0, 2_1, 2_2, 2_3, 2_4 and applicability of the information in the DCI formats are the same as in Release 15 and 16 of the 3GPP specifications.

When CCS from sSCell to PCell/PSCell is configured, the UE monitors DCI formats 0_0 and 1_0 in CSS that schedule PDSCH/PUSCH on PCell/PSCell only on the PCell/PSCell and not on the sSCell.

Two types of UEs (Type A and Type B) can support CCS from sSCell to P(S) Cell:
For Type A UE
   At least the following search space sets on P(S) Cell and search space sets on sSCell are configured so that the UE does not monitor them in overlapping [slot/symbol] of P(S) Cell and sSCell:
      search space sets on P(S) Cell
         USS sets for DCI formats 0_1,1_1,0_2,1_2 (if supported for Type A UE)
         USS sets for DCI formats 0_0,1_0
         Type3-CSS set(s) for DCI formats 1_0/0_0 with C-RNTI/CS-RNTI/MCS-C-RNTI”
      search space sets on sSCell
         USS set(s) for scheduling P(S) Cell
For Type B UE
   Following search space sets on P(S) Cell and search space sets on sSCell can be configured so that the UE monitors them in overlapping [slot/symbol] of P(S) Cell and sSCell:
      search space sets on P(S) Cell
         USS sets for DCI formats 0_0,1_0
         Type3-CSS set(s) for DCI formats 1_0/0_0 with C-RNTI/CS-RNTI/MCS-C-RNTI
      search space sets on sSCell
         USS set(s) for scheduling P(S) Cell
   UE can monitor DCI formats 0_1,1_1,0_2,1_2 on both PCell USS set(s) and sSCell USS sets simultaneously
   There is no restriction on Type-0/0A/1/2-CSS sets configurations

If a MAC entity is configured with one or more SCells, the network may selectively activate and deactivate the configured SCells. Upon configuration of an SCell, the SCell is deactivated unless the parameter sCellState is set to activated for the SCell by upper layers. The configured SCell(s) is activated and deactivated by:
receiving the SCell Activation/Deactivation MAC CE described in 3GPP TS 38.321 clause 6.1.3.10;
configuring sCellDeactivationTimer timer per configured SCell (except the SCell configured with PUCCH, if any): the associated SCell is deactivated upon its expiry; and
configuring sCellState per configured SCell: if configured, the associated SCell is activated upon SCell configuration.

The MAC entity shall for each configured SCell:

| | |
|---|---|
| 1> | if an SCell is configured with sCellState set to activated upon SCell configuration, or |

an SCell Activation/Deactivation MAC CE is received activating the SCell:

| | |
|---|---|
| 2> | start or restart the sCellDeactivationTimer associated with the SCell according to the |
| | timing defined in TS 38.213 [6] for MAC CE activation and according to the timing |
| | defined in TS 38.133 [11] for direct SCell activation; |
| 1> | else if an SCell Activation/Deactivation MAC CE is received deactivating the SCell, or |
| 1> | if the sCellDeactivationTimer associated with the activated SCell expires: |
| 2> | deactivate the SCell according to the timing defined in TS 38.213 [6]; and |
| 2> | stop the sCellDeactivationTimer associated with the SCell; |
| 1> | if PDCCH on the activated SCell indicates an uplink grant or downlink assignment, or |
| 1> | if PDCCH on the Serving Cell scheduling the activated SCell indicates an uplink grant |

or a downlink assignment for the activated SCell, or

| | |
|---|---|
| 1> | if a MAC PDU is transmitted in a configured uplink grant and LBT failure indication is |

not received from lower layers, or

| | |
|---|---|
| 1> | if a MAC PDU is received in a configured downlink assignment: |
| 2> | restart the sCellDeactivationTimer associated with the SCell. |

The sCellDeactivation Timer is (re)-started when the SCell is activated, or when there is PDCCH for an uplink grant and downlink assignment on this SCell or on the other cell (PCell or other SCells) that schedules this SCell, or when there is a MAC protocol data unit (PDU) transmission in a configured uplink grant, or when there is a MAC PDU reception in a configured downlink assignment. If the sCellDeactivation Timer expires, then the SCell is de-activated.

The sCellDeactivation Timer is configured per serving cell as shown below.

--------------- begin excerpt of 3GPP specification -------------------------------------

| | |
|---|---|
| ServingCellConfig ::= | SEQUENCE { |
| sCellDeactivationTimer | ENUMERATED {ms20, ms40, ms80, |

ms160, ms200, ms240,

ms320, ms400,

ms480, ms520, ms640, ms720,

ms840, ms1280,

spare2, spare1}
}
--------------- end excerpt of 3GPP specification -------------------------------------

This field is optionally present for SCell except PUCCH SCells (a Secondary Cell configured with PUCCH). It is absent for PUCCH SCells. If the field is absent, the UE applies the value infinity, i.e., setting the associated timer such that it never expires.

In NR, the UE can skip a MAC PDU transmission in the uplink grant if there is no data to transmit, i.e., the MAC PDU includes zero MAC SDUs or MAC CEs except periodic/padding BSR MAC CE. At the same time, there are some exceptions in which the UE must build a MAC PDU which is to facilitate lower layer processing. There are two of these exceptions: if there are UCIs to be multiplexed on that PUSCH transmission or an aperiodic CSI requested for that PUSCH transmission. The MAC specification 3GPP 38.321 v16.6.0 clause 5.4.3.1.3 is copied below:

```
--------------- begin excerpt of 3GPP specification -------------------------------------
The MAC entity shall:
  1>if the MAC entity is configured with enhancedSkipUplinkTxDynamic
    with value true and the grant indicated to the HARQ entity was
    addressed to a C-RNTI, or if the MAC entity is configured with
    enhancedSkipUplinkTxConfigured with value true and the grant
    indicated to the HARQ entity is a configured uplink grant:
    2>if there is no UCI to be multiplexed on this PUSCH
      transmission as specified in TS 38.213 [6]; and
    2>if there is no aperiodic CSI requested for this PUSCH
      transmission as specified in TS 38.212 [9]; and
    2>if the MAC PDU includes zero MAC SDUs; and
    2>if the MAC PDU includes only the periodic BSR and there is no
      data available for any LCG, or the MAC PDU includes only the
      padding BSR:
      3>not generate a MAC PDU for the HARQ entity.
  1>else if the MAC entity is configured with skipUplinkTxDynamic
    with value true and the grant indicated to the HARQ entity was
    addressed to a C-RNTI, or the grant indicated to the HARQ entity
    is a configured uplink grant; and
  1>if there is no aperiodic CSI requested for this PUSCH
    transmission as specified in TS 38.212 [9]; and
  1>if the MAC PDU includes zero MAC SDUs; and
  1>if the MAC PDU includes only the periodic BSR and there is no
    data available for any LCG, or the MAC PDU includes only the
    padding BSR:
    2>not generate a MAC PDU for the HARQ entity.
--------------- end excerpt of 3GPP specification -------------------------------------
```

Dynamic spectrum sharing (DSS) provides a very useful migration path from LTE to NR by allowing LTE and NR to share the same carrier. DSS was included already in Release 15 of the 3GPP specifications and further enhanced in Release 16. As the number of NR devices in a network increase, it is important that sufficient scheduling capacity for NR UEs on the shared carriers is ensured. It has been identified for NR P(S) Cell in the low band shared with the LTE that there is a PDCCH resource restriction for NR UEs, since the first two OFDM symbols are used for the LTE UEs' PDCCH. It is beneficial to have SCell (typically in mid/high band) to cross schedule PCell and thus further improve PDCCH capacity/coverage for P(S) Cell.

However, if this SCell (i.e., the SCell configured with cross-carrier scheduling (CCS) to PCell/PSCell) is de-activated, then the scheduling for the PCell would be limited and thus undesirable. For example, if there is no PDCCH for UL grant and DL assignment on this SCell, or if there is no MAC PDU transmission in a configured uplink grant or MAC PDU reception in a configured downlink assignment for a time duration determined by sCellDeactivationTimer, then the SCell is de-activated. This would increase the latency of the data transmission. Suppose the UE has no data to receive/transmit on the SCell for a while (leading to SCell de-activation). If there is a burst of data for UE to transmit/receive (beyond the scheduling capability on the PCell with its own self-scheduling PDCCH capability), then the network has to re-activate the SCell (using a MAC Control Element) to be able to schedule the transmission on the PCell rather than directly scheduling it with a DCI command. The MAC Control Element (CE) command typically takes a dozen of milliseconds while DCI command has almost no delay. Thus, deactivation of the scheduling SCell can lead to unacceptable delays.

### SUMMARY

The techniques described herein include various methods to ensure that the SCell configured to schedule a PCell or PSCell is not deactivated due to the expiry of the SCell Deactivation timer. These methods use one of two approaches. In a first approach, the SCell Deactivation timer is not effectively used, e.g., it is not configured or it is configured with a value of infinity. In a second approach, the SCell Deactivation is used, but the network takes actions to ensure that the timer is always restarted before it expires.

An example method is carried out by a network node serving a wireless device and comprises the step of determining that a secondary cell configured for the wireless device is configured for cross-carrier scheduling of a primary cell configured for the wireless device. The method further comprises the step of, responsive to this determining, taking one or more actions to prevent deactivation of the secondary cell.

These actions may include, in some embodiments, omitting a deactivation timer field from a message configuring the secondary cell for cross-carrier scheduling of the primary cell. In other embodiments, these actions may include sending an SCell Activation/Deactivation MAC CE to the wireless device to trigger restarting of a deactivation timer for the secondary cell. In still other embodiments, these actions may include periodically sending a downlink assignment or uplink grant to the wireless device, on the secondary cell. These and other examples are detailed below.

Another example method is carried out by a wireless device operating in a wireless network. This example method comprises determining that a secondary cell configured for the wireless device is configured for cross-carrier scheduling of a primary cell configured for the wireless device and, responsive to this determining, taking one or more actions with respect to a deactivation timer for the secondary cell. In various embodiments, these actions may include ignoring a configuration for the deactivation timer received from the wireless network, or refraining from starting the deactivation timer for the secondary cell, or refraining from any action responsive to expiry of the timer.

Still another example method is also carried out by a wireless device operating in a wireless network. This method comprises the step of receiving a configuration for a secondary cell and, responsive to determining that the configuration for the secondary cell omits a deactivation timer field for the secondary cell, refraining from starting or running a deactivation timer for the secondary cell or running the deactivation timer for the secondary cell in such a way that ensures the deactivation timer does not expire.

As described below, these and other similar techniques and their corresponding apparatuses and systems may be used to ensure that there is always sufficient PDCCH capacity for NR UEs' P(S) Cell to dynamically share spectrum with other LTE UEs. This in turn ensures a low delay of data transmissions.

### BRIEF DESCRIPTION OF THE DRAWINGS

FIGS. 1, 2, and 3 are process flow diagrams illustrating example methods according to some embodiments.

FIG. 4 shows an example of a communication system in accordance with some embodiments.

FIG. 5 shows a wireless device in accordance with some embodiments.

FIG. 6 shows a network node in accordance with some embodiments.

FIG. 7 is a block diagram of a host.

FIG. 8 is a block diagram illustrating a virtualization environment in which functions implemented by some embodiments may be virtualized.

FIG. 9 shows a communication diagram of a host communicating via a network node with a wireless device over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As noted above, the techniques described herein include various methods to ensure that the SCell configured to schedule a PCell or PSCell is not deactivated due to the expiry of the SCell Deactivation timer. These methods use one of two approaches. In a first approach, the SCell Deactivation timer is not effectively used, e.g., it is not configured or it is configured with a value of infinity. In a second approach, the SCell Deactivation is used, but the network takes actions to ensure that the timer is always restarted before it expires.

Some embodiments are based on modifying the configuration of an SCell for a UE by the network to ensure that an SCell that is configured for cross-scheduling of a PCell/PSCell is not deactivated. In one approach, the SCell Deactivation Timer is not configured for the SCell configured with cross-carrier scheduling (CCS) to PCell/PSCell. This is to make sure that this SCell will not be de-activated due to the expiry of the timer.

For example, it may be specified in the RRC spec that the field sCellDeactivationTimer is always absent for the SCell configured with cross-carrier scheduling (CCS) to PCell/PSCell. If the field is absent, the UE applies the value infinity so that even if the timer is started, it never expires.

In another example, the gNB (NR base station) does not configure the field sCellDeactivationTimer for the SCell configured with cross-carrier scheduling (CCS) to PCell/PSCell, i.e., omitting this field from the configuration message(s) sent to the UE. This can be done upon configuration of this SCell to cross-carrier scheduling to PCell/PSCell. If the field is absent, the UE applies the value infinity so that even if the timer would be started but it would never be expired.

If at a first time, an SCell is not configured to schedule the PCell, the network may configure the sCellDeactivationTimer for this SCell. However, if at a later point in time the network configures the SCell to schedule the PCell, the network would deconfigure this timer. The UE may, upon such deconfiguration, seize/cease to use the timer. To seize/cease to use the timer may imply that the UE will refrain from deactivating the SCell in response to the timer expires, or that the UE stops the timer (without taking actions in response to such stopping), or starts the timer with an infinite duration, etc.

Another approach is that a UE will, even if the network configures the sCellDeactivationTimer, refrain from applying certain aspects of the timer. The UE may, for example, ignore such a configuration. To refrain from using the timer may imply that the UE refrains from starting the timer, refrains from taking any action upon expiry of the timer, etc.

Other embodiments are based on modifying scheduling procedures to ensure that an SCell that is configured for cross-scheduling of a PCell/PSCell is not deactivated. In these embodiments, the SCell Deactivation Timer can be configured for the SCell configured with cross-carrier scheduling, but the network implementation ensures that the timer will not be expired, by communicating with the UE on or for that SCell.

Such communication may, for example, be periodic, e.g., by scheduling UL/DL transmissions for this UE, where the periodicity is shorter than the configured SCell Deactivation Timer value. The periodic communication can be done by the following examples:
1. The network periodically schedules a PDCCH for the DL assignment or the UL grant.
2. The network configures a configured downlink assignment with a periodicity, and transmits a MAC PDU in each periodically occurring configured downlink assignment.
3. The network sends an SCell Activation/Deactivation MAC CE, indicating the SCell needs to be activated. The UE will, in response to applying such a MAC CE, restart the sCellDeactivationTimer.

In another example, the network occasionally schedules a PDCCH for the DL assignment or the UL grant, such that the time difference between any two PDCCHs for the DL assignment or the UL grant is shorter than the duration of the SCell Deactivation Timer.

In another example, the network configures a configured uplink grant with a periodicity, and ensures that there is a MAC PDU transmission in configured uplink grant, e.g.:
1. The network configures enhancedSkipUplinkTxConfigured with value true, but schedules a UCI to be multiplexed on this PUSCH transmission or aperiodic CSI request for this PUSCH transmission—
   a. periodically, with a periodicity shorter than the duration of the SCell Deactivation Timer or
   b. occasionally, but such that the time difference between any two instances of either UCI to be multiplexed or aperiodic CSI requested is shorter than the duration of the SCell Deactivation Timer.
2. Network does not configure enhancedSkipUplinkTxConfigured with value true, but schedules an aperiodic CSI request for this PUSCH transmission—
   a. periodically, with a periodicity shorter than the duration of the SCell Deactivation Timer or
   b. occasionally, but such that the time difference between any two instances of aperiodic CSI requested is shorter than the duration of the SCell Deactivation Timer.

In the above discussion, examples of the presently disclosed techniques are described in the context of the 3GPP specifications for NR and LTE. Thus, 3GPP terminology is used. It should be appreciated, however, that the techniques are applicable to other wireless systems in which cross-scheduling of carriers is employed, where the specific terminology may differ.

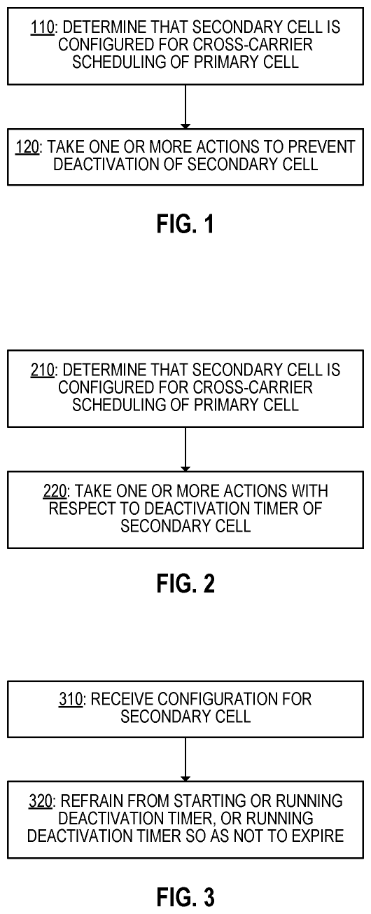

FIG. 1 illustrates an example method, as implemented by a network node serving a wireless device. This method is a generalization of several of the techniques described above, and should be understand as encompassing those techniques. Thus, wherever there are differences in terminology, the terms used in connection with FIG. 1 should be understood as generalizations or synonyms of the terms used in describing the detailed examples above. For example, the term “network node” is a generalization of the 3GPP term “gNB.” Furthermore, variations and modifications described in connection with the examples above are applicable to the method shown in FIG. 1, even if those variations are not explicitly discussed below.

As shown at block 110, the method of FIG. 1 begins with the step of determining that a first cell, e.g., an SCell, configured for the wireless device is configured for cross-carrier scheduling of a second cell, e.g., a PCell or PSCell, configured for the wireless device. As shown at block 120, the network node, in response to this determination, takes one or more actions to prevent deactivation of the first cell, e.g., the SCell. Note that in the figure and the remainder of this description of the method in FIG. 1, the “first cell” is referred to as an SCell (secondary cell) while the second cell is referred to as a PCell. However, the method is more generally applicable to first and second cells where the first is configured for cross-carrier scheduling of the other.

In some embodiments or instances, taking one or more actions comprises refraining from configuring a deactivation timer for the secondary cell. In some of these embodiments or instances, for example, this comprises omitting a deactivation timer field from a message configuring the secondary cell for cross-carrier scheduling of the primary cell.

In other embodiments or instances, taking one or more actions may comprise sending an SCell Activation/Deactivation MAC CE to the wireless device to trigger restarting of a deactivation timer for the secondary cell. In some of these embodiments or instances, the SCell Activation/Deactivation MAC CE is sent periodically.

In some embodiments or instances, taking one or more actions may comprise periodically sending a downlink assignment or uplink grant to the wireless device, on the secondary cell. Likewise, taking one or more actions may comprise configuring a periodic downlink assignment for the secondary cell and sending a PDU to the wireless device for each of a plurality of the configured downlink assignments, or configuring a periodic uplink grant for the secondary cell and scheduling an uplink control information (UCI) transmission or aperiodic channel state information (CSI) transmission by the wireless device for each of a plurality of the configured uplink grants.

FIG. 2 illustrates another example method, as implemented by a wireless device operating in a wireless network. Again, this method is a generalization of several of the techniques described above and should be understand as encompassing those techniques. So, wherever there are differences in terminology, the terms used in connection with FIG. 2 should be understood as generalizations or synonyms of the terms used in describing the detailed examples above. For example, the term “wireless device” is a generalization of the 3GPP-specific term “UE.” Furthermore, variations and modifications described in connection with the examples above are applicable to the method shown in FIG. 2, even if those variations are not explicitly discussed below.

As shown at block 210, the method illustrated in FIG. 2 comprises the step of determining that a first cell, e.g., an SCell, configured for the wireless device is configured for cross-carrier scheduling of a second cell, e.g., a PCell or PSCell, configured for the wireless device. As shown at block 220, the wireless device, responsive to said determining, takes one or more actions with respect to a deactivation timer for the first cell, e.g., the SCell. Again, note that in the figure and the remainder of this description of the method in FIG. 1, the “first cell” is referred to as an SCell while the second cell is referred to as a PCell. Again, however, the method is more generally applicable to first and second cells where the first is configured for cross-carrier scheduling of the other.

In some embodiments or instances, taking one or more actions with respect to the deactivation timer may comprise ignoring a configuration for the deactivation timer received from the wireless network. In others, taking one or more actions with respect to the deactivation timer may comprise refraining from starting the deactivation timer for the secondary cell, or refraining from any action responsive to expiry of the timer.

FIG. 3 illustrates another method as might be implemented by a wireless device operating in a wireless network. As shown at block 310, this method comprises receiving a configuration for a cell, e.g., an SCell. As shown at block 320, the wireless device, responsive to determining that the configuration for the cell omits a deactivation timer field for the cell, refrains from starting or running a deactivation timer for the cell (e.g., the SCell), or it runs the deactivation timer for the cell in such a way that ensures the deactivation timer does not expire, e.g., by setting the deactivation timer to a value of “infinity.”

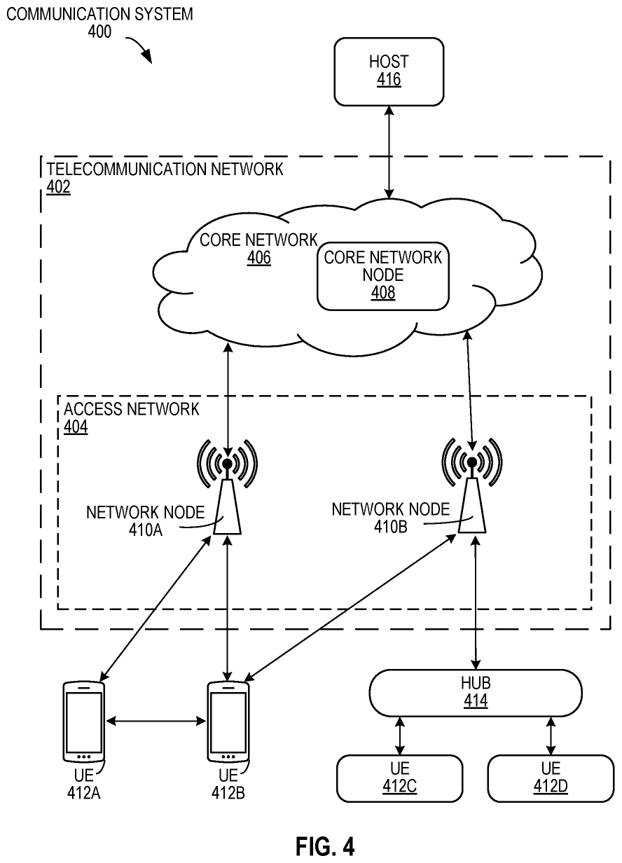

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

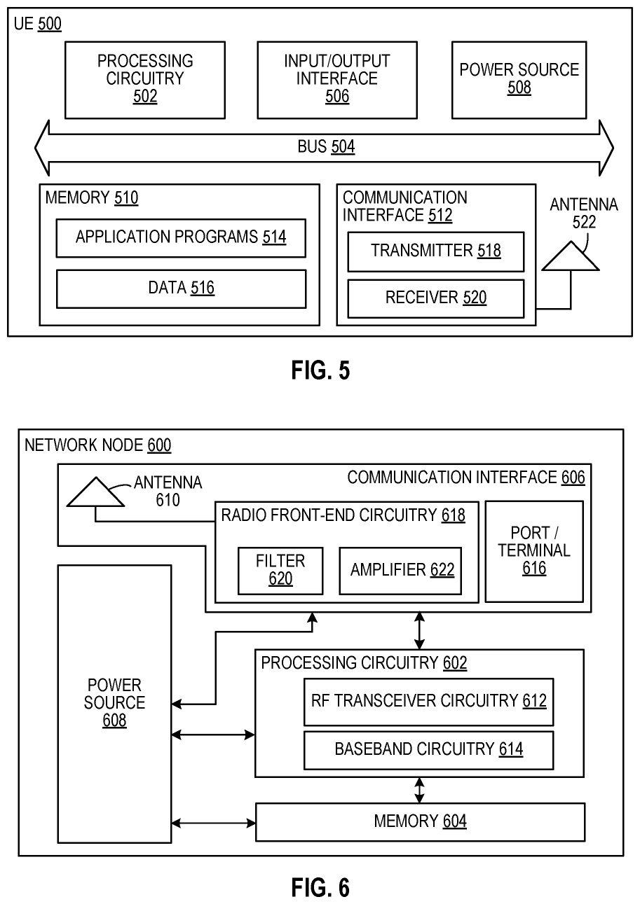

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly.

In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

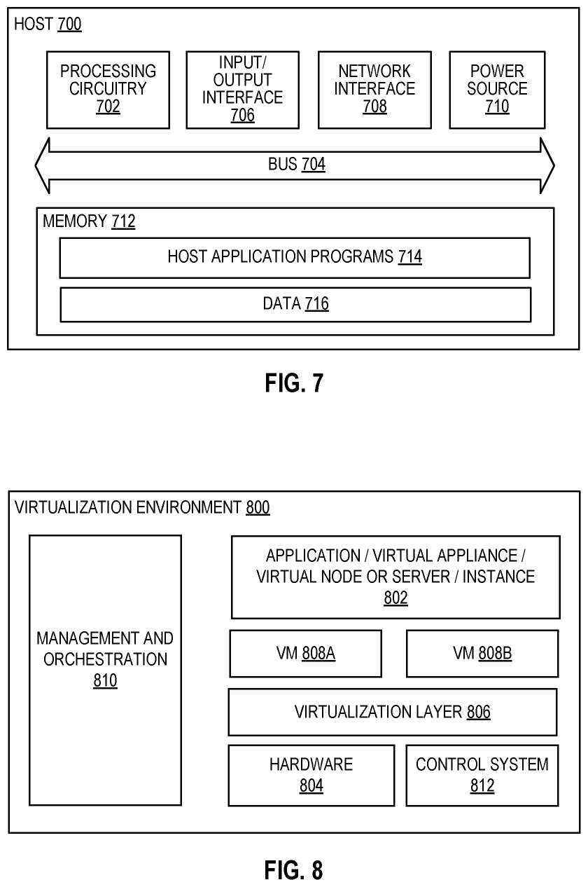

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

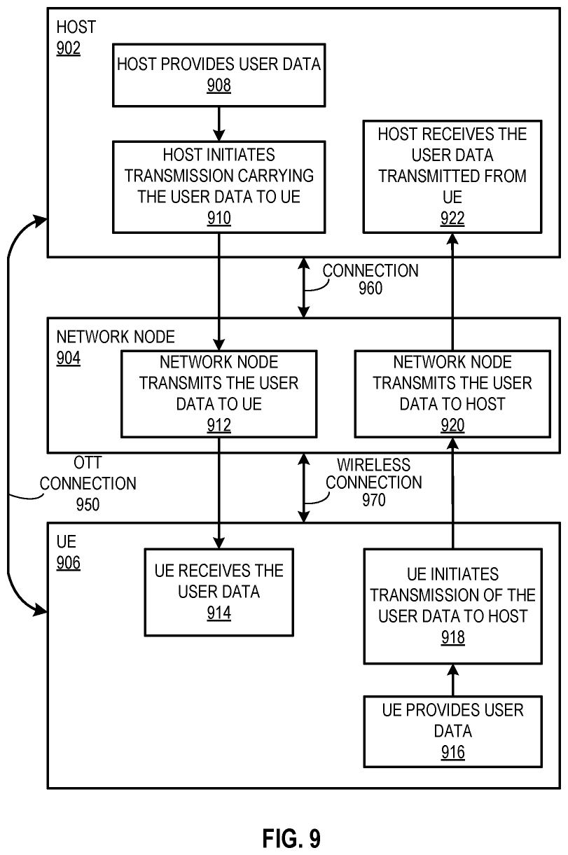

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9. Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, by eliminating unnecessary delays for re-activating a deactivated SCell when a PCell needs to be scheduled, the teachings of these embodiments may improve data rate and latency and thereby provide benefits such as reduced user waiting time.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Embodiments of the techniques, apparatuses, and systems described above include, but are not limited to, the following enumerated examples.
1. A method, in a network node serving a wireless device, the method comprising:
   determining that a first cell configured for the wireless device is configured for cross-carrier scheduling of a second cell configured for the wireless device; and
   responsive to said determining, taking one or more actions to prevent deactivation of the first cell.
2. The method of example embodiment 1, wherein the first cell is a secondary cell, SCell, and the second cell is a primary cell, PCell, or primary secondary cell, PSCell.
3. The method of example embodiment 1 or 2, wherein taking one or more actions comprises refraining from configuring a deactivation timer for the first cell.
4. The method of example embodiment 3, wherein said refraining comprises omitting a deactivation timer field from a message configuring the first cell for cross-carrier scheduling of the second cell.
5. The method of example embodiment 2, wherein taking one or more actions comprises sending an SCell Activation/Deactivation MAC CE to the wireless device to trigger restarting of a deactivation timer for the secondary cell.
6. The method of example embodiment 5, wherein taking one or more actions comprises periodically sending the SCell Activation/Deactivation MAC CE to the wireless device.
7. The method of example embodiment 1 or 2, wherein taking one or more actions comprises periodically sending a downlink assignment or uplink grant to the wireless device, on the first cell.
8. The method of example embodiment 1 or 2, wherein taking one or more actions comprises configuring a periodic downlink assignment for the first cell and sending a protocol data unit, PDU, to the wireless device for each of a plurality of the configured downlink assignments.
9. The method of example embodiment 1 or 2, wherein taking one or more actions comprises configuring a periodic uplink grant for the first cell and scheduling an uplink control information, UCI transmission or aperiodic channel state information, CSI, transmission by the wireless device for each of a plurality of the configured uplink grants.
10. A method, in a wireless device operating in a wireless network, the method comprising:
   determining that a first cell configured for the wireless device is configured for cross-carrier scheduling of a second cell configured for the wireless device; and
   responsive to said determining, taking one or more actions with respect to a deactivation timer for the first cell.
11. The method of example embodiment 11, wherein the first cell is a secondary cell, SCell, and the second cell is a primary cell, PCell, or primary secondary cell, PSCell.
12. The method of example embodiment 10 or 11, wherein taking one or more actions with respect to the deactivation timer comprises ignoring a configuration for the deactivation timer received from the wireless network.
13. The method of example embodiment 10 or 11, wherein taking one or more actions with respect to the deactivation timer comprises refraining from starting the deactivation timer for the first cell.
14. The method of example embodiment 10 or 11, wherein taking (220) one or more actions with respect to the deactivation timer comprises refraining from any action to deactivate the first cell responsive to expiry of the timer.
15. A method, in a wireless device operating in a wireless network, the method comprising:
   receiving a configuration for a first cell; and
   responsive to determining that the configuration for the first cell omits a deactivation timer field for the first cell, refraining from starting or running a deactivation timer for the first cell or running the deactivation timer for the first cell in such a way that ensures the deactivation timer does not expire.
16. The method of example embodiment 15, wherein the first cell is a secondary cell, SCell.
17. A network node comprising transceiver circuitry configured to communicate with a wireless device served by the network node and processing circuitry operatively coupled to the transceiver circuitry, wherein the processing circuitry is configured to carry out a method according to any one of example embodiments 1-9.
18. A network node adapted to carry out a method according to any one of example embodiments 1-9.
19. A wireless device comprising transceiver circuitry configured to communicate with a wireless network and processing circuitry operatively coupled to the transceiver circuitry, wherein the processing circuitry is configured to carry out a method according to any one of example embodiments 10-16.
20. A wireless device adapted to carry out a method according to any one of example embodiments 10-16.

1-34. (canceled)

35. A method, in a network node serving a wireless device, the method comprising:
determining that a first cell configured for the wireless device is configured for cross-carrier scheduling of a second cell configured for the wireless device; and
responsive to said determining, taking one or more actions to prevent deactivation of the first cell.

36. The method of claim 35, wherein the first cell is a secondary cell (SCell) and the second cell is a primary cell (PCell) or primary secondary cell (PSCell).

37. The method of claim 35, wherein taking one or more actions comprises refraining from configuring a deactivation timer for the first cell.

38. The method of claim 37, wherein said refraining comprises omitting a deactivation timer field from a message configuring the first cell for cross-carrier scheduling of the second cell.

39. The method of claim 36, wherein taking one or more actions comprises sending, to the wireless device, an SCell Activation/Deactivation MAC CE indicating the SCell is to be activated, to trigger restarting of a deactivation timer for the SCell.

40. The method of claim 39, wherein taking one or more actions comprises periodically sending the SCell Activation/Deactivation MAC CE to the wireless device.

41. The method of claim 35, wherein taking one or more actions comprises sending a downlink assignment or uplink grant to the wireless device, on the first cell, to trigger restarting of a deactivation timer for the first cell.

42. The method of claim 41, wherein taking one or more actions comprises configuring a periodic downlink assignment for the first cell and sending a protocol data unit (PDU) to the wireless device for each of a plurality of the configured downlink assignments.

43. The method of claim 41, wherein taking one or more actions comprises configuring a periodic uplink grant for the first cell and scheduling an uplink control information (UCI) transmission or aperiodic channel state information (CSI) transmission by the wireless device for each of a plurality of the configured uplink grants.

44. A method, in a wireless device operating in a wireless network, the method comprising:
determining that a first cell configured for the wireless device is configured for cross-carrier scheduling of a second cell configured for the wireless device; and
responsive to said determining, taking one or more actions with respect to a deactivation timer for the first cell.

45. The method of claim 45, wherein the first cell is a secondary cell (SCell) and the second cell is a primary cell (PCell) or primary secondary cell (PSCell).

46. The method of claim 44, wherein taking one or more actions with respect to the deactivation timer comprises ignoring a configuration for the deactivation timer received from the wireless network.

47. The method of claim 44, wherein taking one or more actions with respect to the deactivation timer comprises refraining from starting the deactivation timer for the first cell.

48. A network node comprising radio front-end circuitry configured to communicate with a wireless device served by the network node and processing circuitry operatively coupled to the radio front-end circuitry, wherein the processing circuitry is configured to:
determine that a first cell configured for the wireless device is configured for cross-carrier scheduling of a second cell configured for the wireless device; and
responsive to said determining, take one or more actions to prevent deactivation of the first cell.

49. A wireless device comprising transmitter circuitry and receiver circuitry configured to communicate with a wireless network and further comprising processing circuitry operatively coupled to the transmitter circuitry and receiver circuitry, wherein the processing circuitry is configured to:
determine that a first cell configured for the wireless device is configured for cross-carrier scheduling of a second cell configured for the wireless device; and
responsive to said determining, take one or more actions with respect to a deactivation timer for the first cell.
